(19) United States
(12) Patent Application Publication
(10) Pub. No.: US 2017/0283117 A1
(43) Pub. Date: Oct. 5, 2017

(54) Waste Cooking Grease Collection and Disposal Apparatus

(71) Applicant: Desiree Cole, Eastham, MA (US)

(72) Inventor: Desiree Cole, Eastham, MA (US)

(21) Appl. No.: 15/089,681

(22) Filed: Apr. 4, 2016

(51) Int. Cl. B65D 25/02; C11B 15/00; B09B 3/00; F24C 15/14

(52) U.S. Cl. CPC B65D 25/02; F24C 15/14; C11B 15/00; B09B 3/0083

(57) ABSTRACT

A waste cooking grease collection and disposal apparatus includes a flexible heat-resistant non-conductive polymeric housing devised to withstand introduction of very hot cooking grease poured therein. The housing includes a base bounded topside by a perimetric wall to enclose an interior volume. Grease collected into the interior volume is transportable thereby to cool within a conditioned space, such as inside a refrigerator, for example. Once the grease is cooled, a block of solidified grease is readily removable from the apparatus by manual deformation of the housing. Since the housing comprises known dimensions, blocks of solidified grease of known dimensions are producible for disposal or reuse, as desired.

### BACKGROUND OF THE INVENTION

Disposal of waste cooking grease presents problems that any person cooking has readily experienced. Grease is often too hot to simply discard into a trash receptacle without risking fire, puncture of the trash bag (whereby grease leaks inside the trash can proper), or damage to the receptacle directly. Discarding grease down the sink creates blockages when the grease hardens as it cools while traveling through pipes, leading to problematic buildup and malodorous vapors. A wastefully large volume of water is also typically used when flushing grease down the drain.

Pouring grease into a container with a high melting point is a common practice, such as a can or bottle, for example, but subsequent disposal of the container is thence required as removal of the grease from the container is impractical. Moreover, such containers are typically taller than wide, with a relatively narrow center of gravity, and thereby lend themselves to being knocked over by accident.

Additionally, the opening of such containers into which the grease is poured is often narrower than the curvature of the cooking vessel from whence the grease is poured, whereby spillage during pouring is common as well as inadvertent deposit of grease around the opening and down the sides of the container. Typically, then, unsanitary conditions frequently result, and grease needs to be cleaned from underlying surfaces whereon the container is stood.

What is needed is waste cooking grease collection and disposal apparatus with a relatively low center of gravity that enables collection of even very hot cooking grease into an interior volume without risk of spilling the grease during pouring, which apparatus includes a flexible heat-resistant non-conductive polymeric housing transportable for position inside a refrigerator, for example, to cool grease collected therein, whereby blocks of solidified grease of known dimensions are readily removable from the housing by manual deformation of the polymeric housing for reuse or disposal as desired. Blocks of grease of known dimensions are, therefore, producible and readily disposable without the inconvenience of disposing of the container, flushing drains and pipes, or attempting to collect hot grease in a myriad of other containers not specifically designed for the purpose and essentially selected off the cuff.

### FIELD OF THE INVENTION

The present waste cooking grease collection and disposal apparatus has been devised to present a flexible heat-resistant non-conductive polymeric housing into which very hot cooking grease may be poured without risk of spillage, and in which housing said grease is enabled cooling into a block of solidified grease of known dimensions for easy disposal, as desired.

The present waste cooking grease collection and disposal apparatus includes a base bounded topside by a perimetric wall. The base and perimetric wall have known dimensions, whereby an interior volume is enclosed by said base and said perimetric wall and into which interior volume grease is collectable. The base includes dimensions suitable to space the perimetric wall as a vertical boundary appropriate to accommodate the curvature of cooking vessels from which grease is likely poured, whereby grease is readily collected into the interior volume without running over the sides or depositing exteriorly relative the housing.

The base includes a width and a length greater than the height of the perimetric wall whereby tipping of the housing is impossible without actually lifting and inverting the housing. The base may be configured to resist lateral displacement upon an underlying surface.

The perimetric wall includes an inward surface coterminous with the interior volume, whereon an inner rim is disposed at approximately two-thirds the height of the perimetric wall. The inner rim demarks an upper limit for collected grease, whereby a quantity of grease collected in the housing that reaches the inner rim thence has a known volume. Subsequent cooling of the grease, by reposition of the housing interior to a cooled or conditioned space, such as a refrigerator for example, effects solidification and a block of solidified grease of known dimensions is producible for easy removal from the apparatus by manual deformation of the flexible housing, whereby the block of solidified grease is forcible from out the housing for reuse or disposal, as desired. The grease is thus readily removable from the housing, and the apparatus is reusable.

The inward surface of the perimetric wall and base may include a lipophobic layer whereby grease is prevented from depositing in direct contact with said surface whereby near complete removal of the grease from the housing is effective during the act of disposal.

### SUMMARY OF THE INVENTION

The present waste cooking grease collection and disposal apparatus has been devised to enable an expedient means of collecting, storing, and disposing of waste cooking grease by the stove side. The present waste cooking grease collection and disposal apparatus enables ready portability of even hot grease to cool interior to a refrigerator, for example, and there solidify into a block of solidified grease of known dimensions for ready disposal as a solid block.

The present waste cooking grease collection and disposal apparatus includes a flexible heat-resistant non-conductive polymeric housing having a base bounded topside by a perimetric wall. An interior volume is thus bounded on five sides for collection of grease therein. The interior volume is open topside.

The housing is heat-resistant whereby contact by even very hot grease straight from the stovetop does not effect deformation of the housing, and the housing thus collects the grease without allowing leakage therefrom. The housing is also non-conductive to heat, whereby heat is prevented from conduction into underlying surfaces or into a user carrying the device for position, for example, interior to a refrigerator wherein cooling of the collected grease is expedited. The housing is not enclosed overtop the base, and heat is rapidly radiated and dissipated upwards from the housing.

The base is longer and wider than the perimetric wall is tall. Stability of the housing is thus effective, and tipping prevented. The base may frictively engage with an underlying surface upon which the housing is positioned, to resist lateral displacement. The housing thus maintains upright position atop such surfaces common to kitchens, such as tile, granite, steel, and other flush and hard surfaces, which otherwise might enable slipping and sliding of other containers (especially when greased exteriorly due to spillage effected during pouring).

An inner rim is disposed upon an inward surface of the perimetric wall, said inner rim delimiting an upper extremity of known volume whereby grease collected within the interior volume is measurable at the inner rim. When the volume of grease collected within the interior volume reaches the inner rim, a known volume of grease has been collected and may be disposed of as a solidified block of known dimensions when appropriately cooled.

Thus a user is enabled disposal of grease directly from a cooking vessel, such as a frying pan, for example, into the present waste cooking grease collection and disposal apparatus without spilling the grease, inadvertently depositing excess grease exteriorly upon the housing, or accidently tipping the housing. Grease is storable within the interior volume and may be congealed and solidified by placing the housing inside a refrigerator. Manual deformation of the base and walls serves to subsequently expel a block of solidified grease from the housing for disposal or reuse, as desired.

The base may include a raised design element disposed to protrude into the interior volume whereby grease solidifying atop the base is imprinted with the design element. The design element may include text in mirror-image (an “enantiomorphic design element”), whereby the imprint upon the block of solidified grease is subsequently readable when the block is removed from the housing.

The housing may include a lipophobic surface disposed upon the inward surface and base, whereby grease is prevented from direct contact with the housing, whereby solidification of the grease into a block of known dimensions enables complete expulsion of the grease from the housing without an appreciable residue remaining upon the housing.

Thus has been broadly outlined the more important features of the present waste cooking grease collection and disposal apparatus so that the detailed description thereof that follows may be better understood and in order that the present contribution to the art may be better appreciated.

Objects of the present waste cooking grease collection and disposal apparatus, along with various novel features that characterize the invention are particularly pointed out in the claims forming a part of this disclosure. For better understanding of the waste cooking grease collection and disposal apparatus, its operating advantages and specific objects attained by its uses, refer to the accompanying drawings and description.

### BRIEF DESCRIPTION OF THE DRAWINGS

### Figures

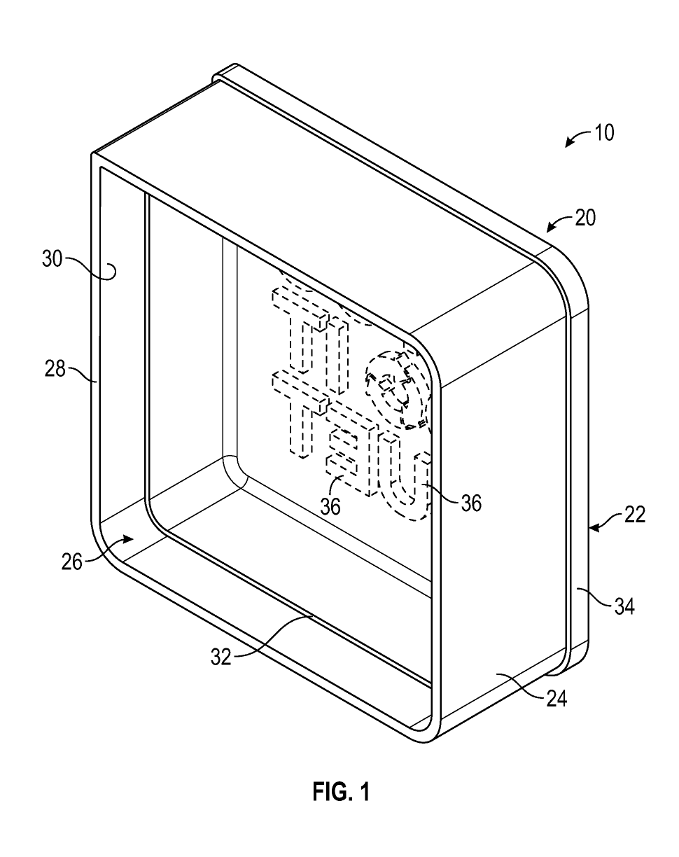

FIG. 1 is an isometric view of an example embodiment.

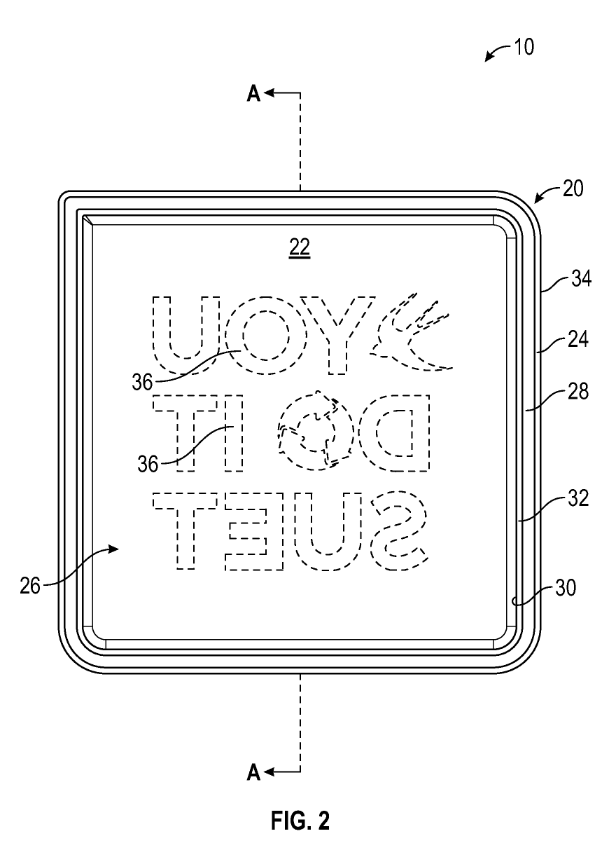

FIG. 2 is a top view of an example embodiment.

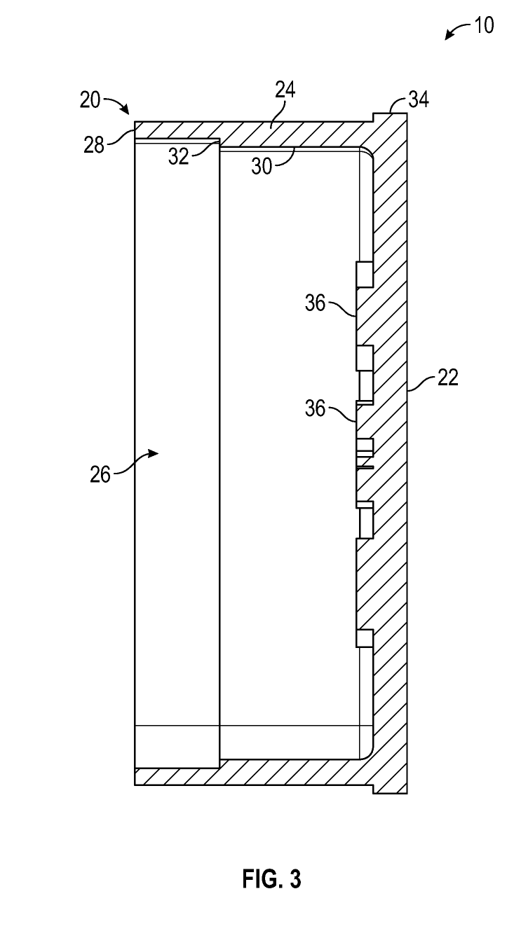

FIG. 3 is a cross-section view taken along the line A-A of FIG. 2.

### DETAILED DESCRIPTION OF THE DRAWINGS

With reference now to the drawings, and in particular FIGS. 1 through 3 thereof, example of the instant waste cooking grease collection and disposal apparatus employing the principles and concepts of the present waste cooking grease collection and disposal apparatus and generally designated by the reference number 10 will be described.

Referring to FIGS. 1 through 3 an example embodiment of the present waste cooking grease collection and disposal apparatus 10 is illustrated.

The present waste cooking grease collection and disposal apparatus 10 has been devised to enable collection of hot cooking grease in the kitchen by the stove side. Once collected, grease storable interior to the present waste cooking grease collection and disposal apparatus 10 is readily cooled and solidified, as with reposition of the present apparatus 10 interior to a refrigerator, wherein cooling and solidification of said collected grease is expedited and easy disposal is subsequently enabled by manual deformation of the present waste cooking grease collection and disposal apparatus 10, whereby a block of solidified grease of known volume is readily expelled from the present waste cooking grease collection and disposal apparatus 10 for disposal or reuse, as desired.

The present waste cooking grease collection and disposal apparatus 10, therefore, includes a flexible heat-resistant non-conductive polymeric housing 20 into which waste grease is pourable for collection. The flexible heat-resistant non-conducive polymeric housing 20 may be formed or molded from thermoset polymer, for example vinyl or silicone. The housing 20 is heat-resistant and prevents deformation even when contacted by hot grease as delivered immediately from a stovetop. Moreover, the housing 20 is thermally non-conductive to prevent heat conduction into underlying surfaces and to enable portability by a user without protective clothing.

The flexible heat-resistant non-conducive polymeric housing 20 includes a base 22 bounded topside by a perimetric wall 22 vertically disposed edgewise upon said base 22. The perimetric wall 24 therefore bounds the base 22 and encloses an interior volume 26 there atop.

A top edge 28 is disposed delimiting an upper extremity of the perimetric wall 24. An inward surface 30 is disposed upon the perimetric wall 24, said inward surface 30 coterminous the interior volume 26. An inner rim 32 is disposed upon the inward surface 30 of the perimetric wall 24 at a height more proximal the top edge 28 than the base 22, said inner rim 32 disposed in a plane parallel with the base 22 to demark an upper limit of collected grease storable within the interior volume and signalize a known volume of said grease once solidified. Solidified blocks of waste cooking grease are thus producible at repeatable and known volumes for use, reuse, or disposal, as desired.

The base 22 is both longer and wider than the perimetric wall 24 is tall. The housing 20 thus presents a love center of gravity whereby tipping is impossible without manually inverting the housing 20. An exterior rim 34 is disposed bounding the base 22 exteriorly around the perimetric wall 24 wherein the base 22 exceeds the delimit of the perimetric wall 24 most proximal the ground whereby stability of the apparatus 10 is yet further increased. A non-slip surface (not shown) may be included exteriorly upon the base 22 to prevent lateral displacement of the device 10 or, alternately, the polymeric housing may frictively engage against an underlying surface due to the material of which the housing 20 is comprised (for example thermoset silicone).

Collection of hot grease poured into the interior volume 26 does not appreciably lessen the stability of the perimetric wall 24 nor deform the base 22, and although flexible enough for manual deformation, the apparatus 10 yet maintains its shape to bound and enclose the interior volume 26 even when contacted by application of hot grease poured therein. A user is thus enabled to pour waste cooking grease into the interior volume 26 from a frying pan, for example, without spilling grease outside of said interior volume 26. Waste cooking grease is thus readily collectable in the interior volume 26 for solidification when cooled, whereby a block of solidified grease of known dimensions is removable from the interior volume 26 by manual deformation of the base 22 and perimetric wall 24.

The waste cooking grease collection and disposal apparatus 10 may also include an enantiomorphic design element 36 raised upon the base 22 to protrude into the interior volume 26 whereby a readable design is formable into the block of solidified grease upon solidification when cooled.

The base 22 is contemplated to be square with an area large enough to position the perimetric wall 24 spaced enough to readily catch grease poured over the rims of most frying pans, whereby spillage and splattering outside the interior volume is unlikely and the grease poured from said frying pans is entirely collectable within the interior volume 26. In an example embodiment contemplated herein, the base dimensions are 5 inches by 5 inches and the perimetric wall 24 extends approximately 2 inches up from the base 22. The inner rim 32 is disposed at approximately 1.3333 inches from the base 22. The perimetric wall 24 may be thicker between the inner rim 32 and the base 22, whereby the solidified block of grease is of a known and consistent size when to occupying the interior volume 26 from the inner rim 32 to the base 22.

A user thus pours waste cooking grease into the interior volume 26 and collects grease as desired. When the level of grease in the interior volume 26 reaches the inner rim 32, a known volume of grease has been collected. Cooling in the refrigerator thus solidifies the grease and enables easy removal of a consistent, standardized, and known volume of grease for disposal or reuse, as desired. In the example embodiment herein contemplated, the volume of the block of solidified grease is approximately 30.72 cubic-inches.

What is claimed is:

1. A waste cooking grease collection and disposal apparatus having a flexible heat-resistant non-conductive polymeric housing into which waste cooking grease is pourable for collection, said housing comprising:
a base disposed to frictively engage an underlying surface and resist lateral displacement thereon;
a perimetric wall disposed edgewise atop the base, said perimetric wall having a height less than both a length and a width of the base;
an interior volume enclosed by the base and the perimetric wall;
a top edge disposed delimiting an upper extremity of the perimetric wall;
an inward surface disposed upon the perimetric wall, said inward surface coterminous the interior volume; and
an inner rim disposed upon the inward surface of the perimetric wall at a position approximately two-thirds the height of the perimetric wall;
wherein collection of hot grease poured into the interior volume does not lessen the stability of the perimetric wall nor deform the base and waste cooking grease is readily collectable in the interior volume for solidification when cooled, whereby a block of solidified grease is removable from the interior volume by manual deformation of the base and perimetric walls.

2. The waste cooking grease collection and disposal apparatus of claim 1 wherein the base includes an enantiomorphic design element raised into the interior volume whereby a readable design is formable into the block of solidified grease upon solidification when cooled.

3. The waste cooking grease collection and disposal apparatus of claim 1 wherein the base is 5 inches long by 5 inches wide.

4. The waste cooking grease collection and disposal apparatus of claim 2 wherein the base is 5 inches long and 5 inches wide.

5. The waste cooking grease collection and disposal apparatus of claim 3 wherein the perimetric wall is 2 inches tall.

6. The waste cooking grease collection and disposal apparatus of claim 4 wherein the perimetric wall is 2 inches tall.

7. The waste cooking grease collection and disposal apparatus of claim 5 wherein the inner rim is disposed upon the inward surface of the perimetric wall 1.333 inches above the base.

8. The waste cooking grease collection and disposal apparatus of claim 6 wherein the inner rim is disposed upon the inward surface of the perimetric wall 1.333 inches above the base.

9. The waste cooking grease collection and disposal apparatus of claim 7 wherein the housing is made of silicone.

10. The waste cooking grease collection and disposal apparatus of claim 7 wherein the housing is lipophobic.

11. The waste cooking grease collection and disposal apparatus of claim 8 wherein the housing is made of silicone.

12. The waste cooking grease collection and disposal apparatus of claim 8 wherein the housing is lipophobic.

13. A waste cooking grease collection and disposal apparatus having a flexible heat-resistant non-conductive polymeric housing into which waste grease is pourable for collection, said flexible heat-resistant polymeric housing comprising:
a base having an length and a width of 5 inches, said base disposed to frictively engage an underlying surface whereon the housing is stood;
a 2 inch perimetric wall vertically disposed upon the base, said perimetric wall bounding the base and enclosing an interior volume;
a top edge disposed delimiting an upper extremity of the perimetric wall;
an inward surface disposed upon the perimetric wall, said inward surface coterminous the interior volume;
an inner rim disposed upon the inward surface of the perimetric wall at 1.33 inches height above the base, said interior rim disposed in a plane parallel with the base;
an exterior rim disposed bounding the base exteriorly around the perimetric wall; and
an enantiomorphic design element raised upon the base to protrude into the interior volume;
wherein collection of hot grease poured into the interior volume dos not appreciably lessen the stability of the walls nor deform the base when contacted therewith, whereby waste cooking grease is readily collectable in the interior volume for solidification when cooled, whereby a block of solidified grease of standardized dimensions and having a known volume is removable from the interior volume by manual deformation of the base and perimetric walls and an imprint of the design element is readable in a surface of the solidified block of grease.

14. The waste cooking grease collection and disposal apparatus of claim 13 wherein the flexible heat-resistant housing is made of silicone.

15. The waste cooking grease collection and disposal apparatus of claim 13 wherein the housing is lipophobic.
